(19) United States
(12) Patent Application Publication
(10) Pub. No.: US 2005/0177732 A1
(43) Pub. Date: Aug. 11, 2005

(54) Intersystem communications

(75) Inventors: Eran Flom, Rishon LeZion (IL); Uriel Segev, Or-Yehuda (IL)

Correspondence Address: SACCO & ASSOCIATES, P.A., P.O. BOX 30999, PALM BEACH GARDENS, FL, 33420-0999, US

(73) Assignee: INTERNATIONAL BUSINESS MACHINES CORPORATION, Armonk, NY (US)

(21) Appl. No.: 11/041,327

(22) Filed: Jan. 24, 2005

(30) Foreign Application Priority Data
Jan. 23, 2004 (GB) 0401412.2

(51) Int. Cl. H04K 1/00

(52) U.S. Cl. 713/182; 726/7

(57) ABSTRACT

A method for managing system user presence, the method including determining the login status of a first user at a first system, and duplicating at a second system the login status of the first user in response to determining the login status.

### CROSS-REFERENCE TO RELATED APPLICATIONS

This application claims the benefit of United Kingdom Application Serial Number 0401412.2 filed on Jan. 23, 2004.

### FIELD OF THE INVENTION

The present invention relates to intersystem communications in general, and more particularly to communications between users of disparate Presence and Instant Messaging (PIM) systems.

### BACKGROUND OF THE INVENTION

As the popularity of Presence and Instant Messaging (PIM) systems, such as AmericaOnline's Instant Messenger® and Microsoft's MSN®, continues to grow, users of different types of PIM systems are increasingly demanding the ability to collaborate with each other. Although gateways may be used to translate and forward messages between users of different types of PIM systems, a user of one type of PIM system cannot rely on the system's local directory to locate users of another type of PIM, a feature which has come to be an essential aspect of instant messaging.

### SUMMARY OF THE INVENTION

The present invention discloses a system and method for managing intersystem communications, particularly between users of different Presence and Instant Messaging (PIM) systems.

In one aspect of the present invention a method is provided for managing system user presence, the method including determining the login status of a first user at a first system, and duplicating at a second system the login status of the first user in response to determining the login status.

In another aspect of the present invention the method further includes the second system maintaining a directory containing information relating to the first user that is required for logging the first user into the second system.

In another aspect of the present invention the method further includes the first and second systems maintaining a shared directory containing information relating to the first user that is required for logging the first user into either of the systems.

In another aspect of the present invention the determining step includes receiving a notification from the first system of a change in login status of the first user at the first system.

In another aspect of the present invention the determining step includes creating a subscription at the first system operative to cause the first system to issue a notification of a change in login status of the first user at the first system.

In another aspect of the present invention the determining step includes periodically polling the first system for the login status of the first user.

In another aspect of the present invention the duplicating step includes duplicating if a notification is received from the first system of a change in login status of the first user at the first system and if the first user appears on a list of users selected from among users of the second system.

In another aspect of the present invention a method is provided for managing system user presence, the method including determining that a first user is logged into a first system, and logging the first user into a second system in response to determining that the user is logged into the first system.

In another aspect of the present invention the method further includes the second system maintaining a directory containing information relating to the first user that is required for logging the first user into the second system.

In another aspect of the present invention the method further includes the first and second systems maintaining a shared directory containing information relating to the first user that is required for logging the first user into either of the systems.

In another aspect of the present invention the method further includes conveying a message from a second user logged in to the second system to the first user at the first system.

In another aspect of the present invention the conveying step includes converting the message from a format compatible with the second system to a format compatible with the first system.

In another aspect of the present invention the determining step includes receiving a notification from the first system of the first user logging in to the first system.

In another aspect of the present invention the determining step includes creating a subscription at the first system operative to cause the first system to issue a notification of a change in login status of the first user at the first system.

In another aspect of the present invention the determining step includes periodically polling the first system for the login status of the first user.

In another aspect of the present invention the logging step includes logging if a notification is received from the first system of the first user logging in to the first system and if the first user appears on a list of users selected from among users of the second system.

In another aspect of the present invention a system is provided for managing system user presence, the system including means for determining the login status of a first user at a first system, and means for duplicating at a second system the login status of the first user in response to determining the login status.

In another aspect of the present invention the system further includes a directory containing information relating to the first user that is required for logging the first user into the second system.

In another aspect of the present invention the system further includes a shared directory containing information relating to the first user that is required for logging the first user into either of the systems.

In another aspect of the present invention the means for determining is operative to receive a notification from the first system of a change in login status of the first user at the first system.

In another aspect of the present invention the means for determining is operative to create a subscription at the first system operative to cause the first system to issue a notification of a change in login status of the first user at the first system.

In another aspect of the present invention the means for determining is operative to periodically poll the first system for the login status of the first user.

In another aspect of the present invention the means for duplicating is operative to duplicate if a notification is received from the first system of a change in login status of the first user at the first system and if the first user appears on a list of users selected from among users of the second system.

In another aspect of the present invention a system is provided for managing system user presence, the system including means for determining that a first user is logged into a first system, and means for logging the first user into a second system in response to determining that the user is logged into the first system.

In another aspect of the present invention the system further includes a directory containing information relating to the first user that is required for logging the first user into the second system.

In another aspect of the present invention the system further includes a shared directory containing information relating to the first user that is required for logging the first user into either of the systems.

In another aspect of the present invention the system further includes means for conveying a message from a second user logged in to the second system to the first user at the first system.

In another aspect of the present invention the means for conveying is operative to convert the message from a format compatible with the second system to a format compatible with the first system.

In another aspect of the present invention the means for determining is operative to receive a notification from the first system of the first user logging in to the first system.

In another aspect of the present invention the means for determining is operative to create a subscription at the first system operative to cause the first system to issue a notification of a change in login status of the first user at the first system.

In another aspect of the present invention the means for determining is operative to periodically poll the first system for the login status of the first user.

In another aspect of the present invention the means for logging in is operative to log in if a notification is received from the first system of the first user logging in to the first system and if the first user appears on a list of users selected from among users of the second system.

In another aspect of the present invention a computer program is provided embodied on a computer-readable medium, the computer program including a first code segment operative to determine the login status of a first user at a first system, and a second code segment operative to duplicate at a second system the login status of the first in response to determining that the user is logged into the first system.

### BRIEF DESCRIPTION OF THE DRAWINGS

The present invention will be understood and appreciated more fully from the following detailed description taken in conjunction with the appended drawings in which:

FIG. 1 is a simplified block-flow diagram of a PIM intersystem communications system, constructed and operative in accordance with a preferred embodiment of the present invention;

FIG. 2 is a simplified flow chart illustration of an exemplary method of operation of the system of FIG. 1, operative in accordance with a preferred embodiment of the present invention;

FIG. 3 is a simplified block-flow diagram of a PIM intersystem communications system, constructed and operative in accordance with a preferred embodiment of the present invention;

FIG. 4 is a simplified flow chart illustration of an exemplary method of operation of the system of FIG. 3, operative in accordance with a preferred embodiment of the present invention;

FIG. 5 is a simplified block-flow diagram of a PIM intersystem communications system, constructed and operative in accordance with a preferred embodiment of the present invention; and

FIG. 6 is a simplified flow chart illustration of an exemplary method of operation of the system of FIG. 5, operative in accordance with a preferred embodiment of the present invention.

### DETAILED DESCRIPTION OF PREFERRED EMBODIMENTS

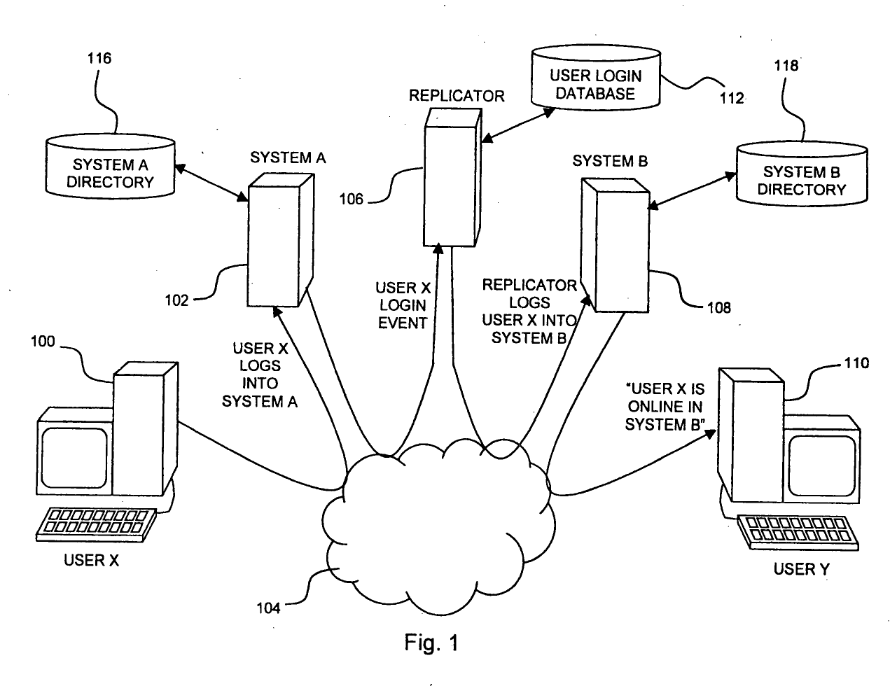

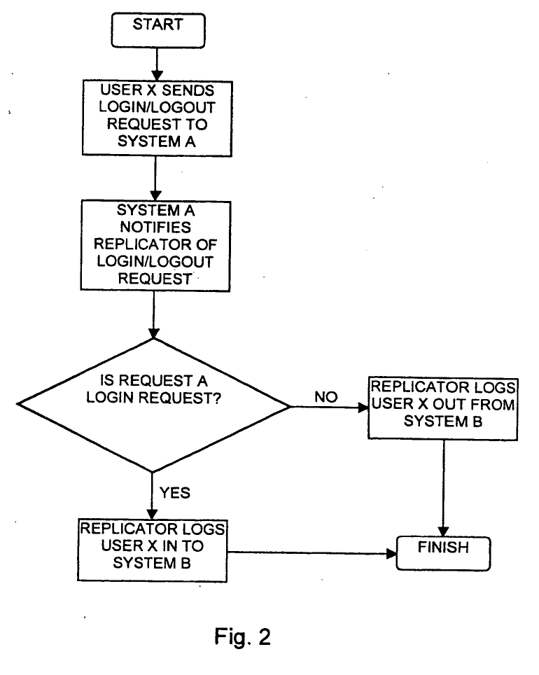

Reference is now made to FIG. 1, which is a simplified block-flow diagram of a PIM intersystem communications system, constructed and operative in accordance with a preferred embodiment of the present invention, and additionally to FIG. 2, which is a simplified flow chart illustration of an exemplary method of operation of the system of FIG. 1, operative in accordance with a preferred embodiment of the present invention. In the system of FIG. 1 and method of FIG. 2, a computer 100 sends a login/logout request identifying a User X to a server 102 via a network 104. The login/logout request may be for logging in to a System A that is hosted at server 102, being, for example, a PIM system such as Lotus Sametime®. System A sends a notification of the login/logout event of User X to a replicator 106. Where the event notification indicates the logging in of User X into System, A, replicator 106 may send a login request identifying User X to a server 108. The login request from replicator 106 may be for logging in to a System B that may be hosted at server 108, being, for example, a PIM system such as Lotus Workplace®. Where the event notification indicates the logging out of User X from System A, replicator 106 may send a logout request identifying User X to a server 108, whereupon replicator 106 may log User X out from System B.

System A and System B respectively maintain information regarding their users in a directory 116 and 118, such as a Lightweight Directory Access Protocol (LDAP) directory, in accordance with conventional techniques. Thus, in order for a user of System A to be logged in to System B, information regarding the System A user, such as the user's login name and password, must be found in the System B directory 118 before the System A user can log into System B. Likewise, in order for a user of System B to be logged in to System A, information regarding the System B user must be found in the System A directory 116 before the System B user can log into System A. Directories 116 and 118 may be separate directories or may be the same directory shared by both Systems A and B.

It will be appreciated that to a User Y at a computer 110 that is logged in to System B, User X will appear to be logged in to System B in the same way as other users who are currently logged in to System B, provided that User Y has the capability of seeing users who are logged in to System B in accordance with conventional techniques. Yet, from the perspective of User X, User X appears to be connected to System A alone. Where User Y may see the network address of users who are currently logged in to System B, the network address of replicator 106 may be used to represent the network address of User X.

It will be further appreciated that replicator 106 may similarly receive a notification of the login of User Y in to System B and send a login request identifying User Y to a server 102 for logging User Y into System A, in which case User Y will appear to User X as logged in to System A, provided that User X has the capability of seeing users who are logged in to System A in accordance with conventional techniques.

The notification of the login of User X preferably includes information identifying User X and that may be used to log User X in to System B, such as a login name and password. Where additional information is required to log User X in to System B, replicator 106 may request such information from System A in accordance with conventional techniques. Additionally or alternatively, replicator 106 may be configured to maintain a user's login information in a database 112 for any of the systems at which replicator 106 may log the user in, including different login names and passwords for the same user for use with different systems.

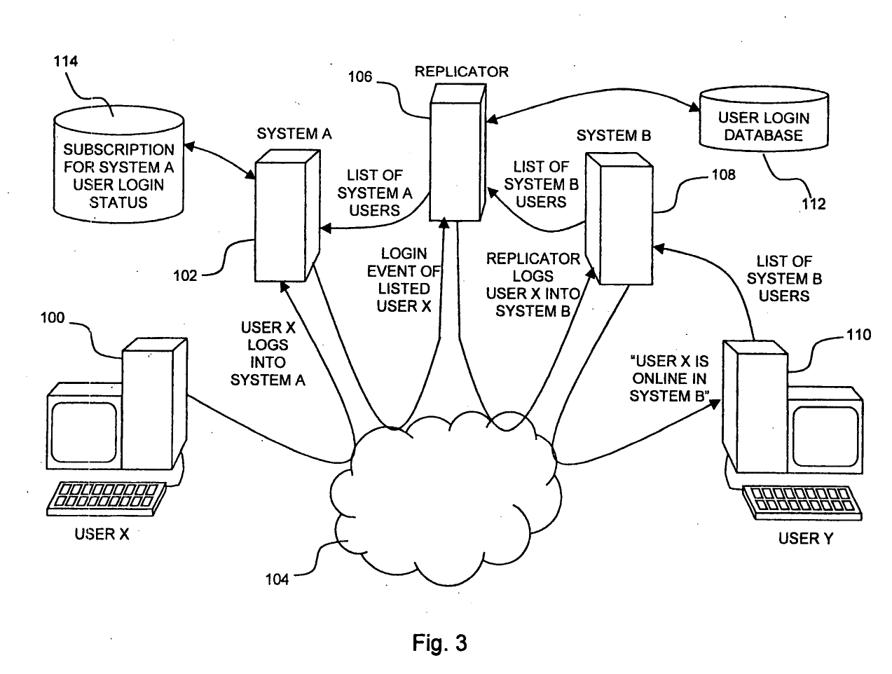

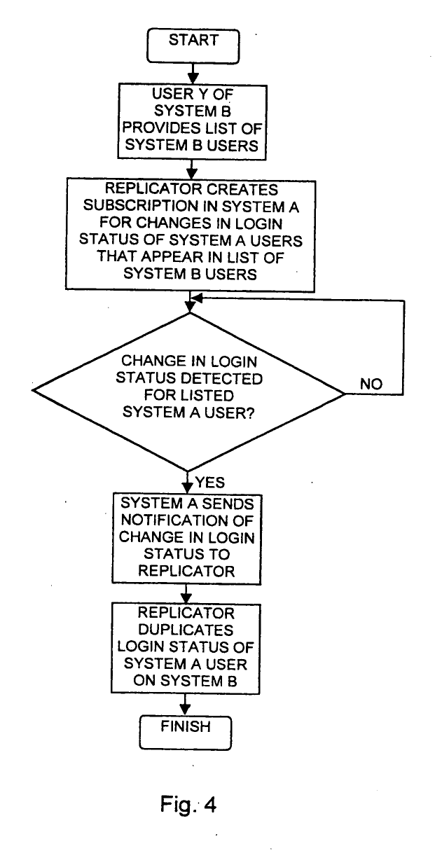

Reference is now made to FIG. 3, which is a simplified block-flow diagram of a PIM intersystem communications system, constructed and operative in accordance with a preferred embodiment of the present invention, and additionally to FIG. 4, which is a simplified flow chart illustration of an exemplary method of operation of the system of FIG. 3, operative in accordance with a preferred embodiment of the present invention. In the system of FIG. 3 and method of FIG. 4, User Y provides System B with a list of System B users whose login status is of interest to User Y. As described hereinabove, the list of System B users may in fact include System A users whose user information is also found in directory 118 of System B and who do not log in directly to System B, but rather whose login to System B is effected by replicator 106. System B in turn provides this list to replicator 106 which may map the identities of the System A users in the list to their System A identities, such as using database 112, where the identities are not the same. Replicator 106 may then create a subscription 114 at server 102 using conventional techniques, requesting that notification of changes in login status of the users in the list, as identified by their System A identities, be provided to replicator 106. In this manner, a filter may be established where replicator 106 is notified by System A only of changes in login status of System A users to whom the subscription pertains. Alternatively, replicator 106 may itself maintain the list, against which login status notifications for all System A users are compared, with only listed users being logged in to System B. Alternatively, replicator 106 may itself maintain the list and periodically poll System A for the login status of listed users. Then, as described hereinabove with reference to FIGS. 1 and 2, replicator 106 may then duplicate with respect to System B the login status of the listed System A user whose login status has changed with respect to system A.

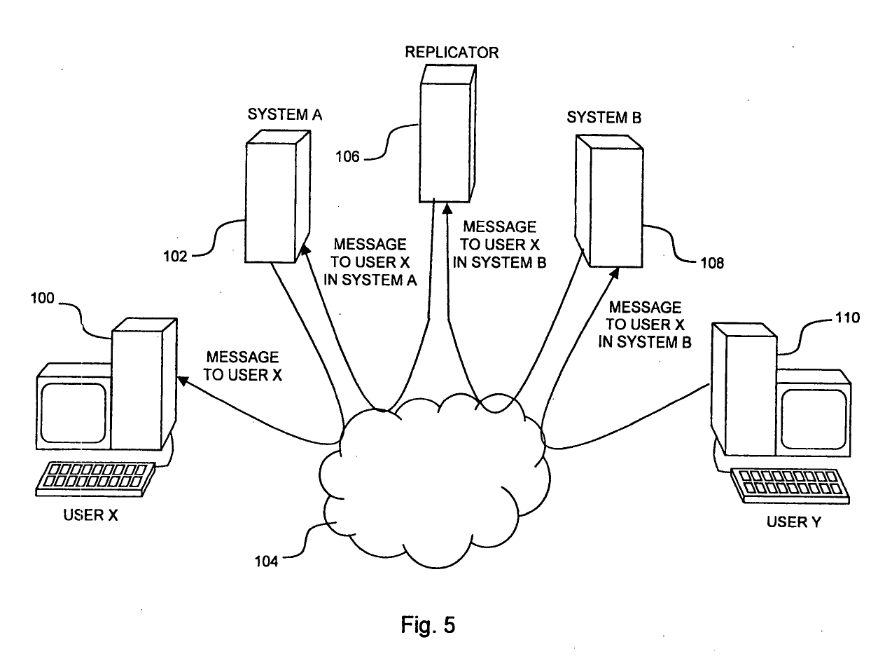

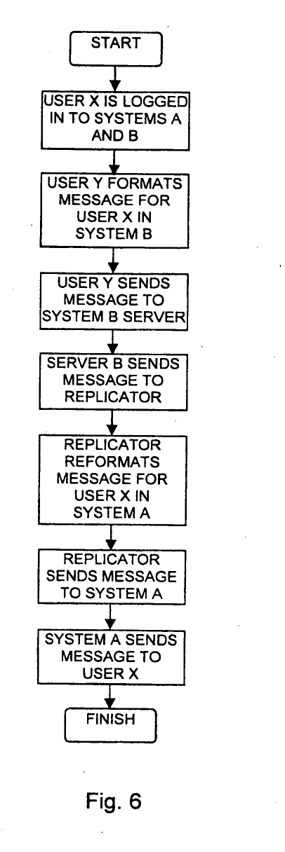

Reference is now made to FIG. 5, which is a simplified block-flow diagram of a PIM intersystem communications system, constructed and operative in accordance with a preferred embodiment of the present invention, and additionally to FIG. 6, which is a simplified flow chart illustration of an exemplary method of operation of the system of FIG. 5, operative in accordance with a preferred embodiment of the present invention. In the system of FIG. 5 and method of FIG. 6, User X is logged directly in to System A, and indirectly into System B by replicator 106 in accordance with the method shown hereinabove with reference to FIGS. 1 and 2. User Y, wishing to send a message to User X, typically formats a message for use with System B and forwards the message to server 108, which in turn forwards the message to replicator 106. Alternatively, User Y may send the message directly to the network address known to it as the network address of User X, which is typically the network address of replicator 106. Replicator 106 may, if necessary, reformat the message for use with System A and forward the message to server 102, which in turn forwards the message to User X.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

1. A method for managing system user presence, the method comprising:
determining the login status of a first user at a first system; and
duplicating at a second system said login status of said first user in response to determining said login status.

2. A method according to claim 1 and further comprising said second system maintaining a directory containing information relating to said first user that is required for logging said first user into said second system.

3. A method according to claim 1 and further comprising said first and second systems maintaining a shared directory containing information relating to said first user that is required for logging said first user into either of said systems.

4. A method according to claim 1 wherein said determining step comprises receiving a notification from said first system of a change in login status of said first user at said first system.

5. A method according to claim 1 wherein said determining step comprises creating a subscription at said first system operative to cause said first system to issue a notification of a change in login status of said first user at said first system.

6. A method according to claim 1 wherein said determining step comprises periodically polling said first system for the login status of said first user.

7. A method according to claim 1 wherein said duplicating step comprises duplicating if a notification is received from said first system of a change in login status of said first user at said first system and if said first user appears on a list of users selected from among users of said second system.

8. A method for managing system user presence, the method comprising:
determining that a first user is logged into a first system; and
logging said first user into a second system in response to determining that said user is logged into said first system.

9. A method according to claim 8 and further comprising said second system maintaining a directory containing information relating to said first user that is required for logging said first user into said second system.

10. A method according to claim 8 and further comprising said first and second systems maintaining a shared directory containing information relating to said first user that is required for logging said first user into either of said systems.

11. A method according to claim 8 and further comprising conveying a message from a second user logged in to said second system to said first user at said first system.

12. A method according to claim 11 wherein said conveying step comprises converting said message from a format compatible with said second system to a format compatible with said first system.

13. A method according to claim 8 wherein said determining step comprises receiving a notification from said first system of said first user logging in to said first system.

14. A method according to claim 8 wherein said determining step comprises creating a subscription at said first system operative to cause said first system to issue a notification of a change in login status of said first user at said first system.

15. A method according to claim 8 wherein said determining step comprises periodically polling said first system for the login status of said first user.

16. A method according to claim 8 wherein said logging step comprises logging if a notification is received from said first system of said first user logging in to said first system and if said first user appears on a list of users selected from among users of said second system.

17. A system for managing system user presence, the system comprising:
means for determining the login status of a first user at a first system; and
means for duplicating at a second system said login status of said first user in response to determining said login status.

18. A system according to claim 17 and further comprising a directory containing information relating to said first user that is required for logging said first user into said second system.

19. A system according to claim 17 and further comprising a shared directory containing information relating to said first user that is required for logging said first user into either of said systems.

20. A system according to claim 17 wherein said means for determining is operative to receive a notification from said first system of a change in login status of said first user at said first system.

21. A system according to claim 17 wherein said means for determining is operative to create a subscription at said first system operative to cause said first system to issue a notification of a change in login status of said first user at said first system.

22. A system according to claim 17 wherein said means for determining is operative to periodically poll said first system for the login status of said first user.

23. A system according to claim 17 wherein said means for duplicating is operative to duplicate if a notification is received from said first system of a change in login status of said first user at said first system and if said first user appears on a list of users selected from among users of said second system.

24. A system for managing system user presence, the system comprising:
means for determining that a first user is logged into a first system; and
means for logging said first user into a second system in response to determining that said user is logged into said first system.

25. A system according to claim 24 and further comprising a directory containing information relating to said first user that is required for logging said first user into said second system.

26. A system according to claim 24 and further comprising a shared directory containing information relating to said first user that is required for logging said first user into either of said systems.

27. A system according to claim 24 and further comprising means for conveying a message from a second user logged in to said second system to said first user at said first system.

28. A system according to claim 27 wherein said means for conveying is operative to convert said message from a format compatible with said second system to a format compatible with said first system.

29. A system according to claim 24 wherein said means for determining is operative to receive a notification from said first system of said first user logging in to said first system.

30. A system according to claim 24 wherein said means for determining is operative to create a subscription at said first system operative to cause said first system to issue a notification of a change in login status of said first user at said first system.

31. A system according to claim 24 wherein said means for determining is operative to periodically poll said first system for the login status of said first user.

32. A system according to claim 24 wherein said means for logging in is operative to log in if a notification is received from said first system of said first user logging in to said first system and if said first user appears on a list of users selected from among users of said second system.

33. A computer program embodied on a computer-readable medium, the computer program comprising:
a first code segment operative to determine the login status of a first user at a first system; and
a second code segment operative to duplicate at a second system said login status of said first in response to determining that said user is logged into said first system.
